(19) United States
(12) Patent Application Publication
(10) Pub. No.: US 2012/0205976 A1
(43) Pub. Date: Aug. 16, 2012

(54) REDUNDANT POWER SYSTEM REGULATING OPERATION ACCORDING TO LOADS

(76) Inventors: Tsun-Te Shih, New Taipei City (TW); Yu-Yuan Chang, New Taipei City (TW); Li-Wei Lu, New Taipei City (TW)

(21) Appl. No.: 13/024,796

(22) Filed: Feb. 10, 2011

(51) Int. Cl. H02J 4/00

(52) U.S. Cl. 307/24; 307/29

(57) ABSTRACT

A redundant power system regulating operation according to loads includes a power back panel and a plurality of power supplies electrically connected to a plurality of input ports on the power back panel. The power back panel has a plurality of output ports electrically connected to at least one load. Each power supply has an ON/OFF control terminal to receive an ON/OFF signal to determine ON or OFF thereof. The power back panel further has a power source management unit to detect the number of the load being activated. The power source management unit includes a plurality of ON/OFF signal terminals electrically connected to the ON/OFF control terminals. The power source management unit determines the number of the ON/OFF signal terminals to output the ON/OFF signal according to the number of the activated load.

### FIELD OF THE INVENTION

The present invention relates to an improved redundant power system regulating operation according to loads.

### BACKGROUND OF THE INVENTION

To ensure power supply stability in an electronic system, a redundant power system including a plurality of power supply units is usually employed. The redundant power system includes a power back panel connected to the aforesaid power supply units to issue an activating signal to activate all the power supply units at the same time.

A conventional technique can be found in R.O.C. patent No. M307787 entitled “Removable composite redundant power system” which discloses a redundant power system including a host housing partitioned into a plurality of main removable compartments each has a main power distribution unit at the inner side. The main power distribution unit has a corresponding main power input port at one side of the main removable compartment and a main power output port at another side, and at least one pluggable power unit in the main removable compartment. The power unit has a secondary power output port electrically connected to the main power input port in a pluggable manner. The power unit also is partitioned into a plurality of secondary removable compartments each has a secondary power input port and holds a power supply electrically connected to the secondary power input port.

The aforesaid R.O.C. patent No. M307787 adopts a technique that allows the redundant power system to install a plurality of power units in the host housing through the main power distribution unit. The power unit includes one or more power supplies to allow the redundant power system to integrate multiple power supplies for output.

Other references of the redundant power system equipped with a power back panel also are seen in prior art. For instance, R.O.C. patent No. I271015 entitled “Redundant power supply with AC/DC power input” includes at least one DC/DC power supply, at least one AC/DC power supply and at least one power control circuit board. The DC/DC power supply and AC/DC power supply are coupled in parallel on the power control circuit board which not only integrates electric power but also balances output power of multiple power supplies and detects malfunction of the power supplies.

While the conventional techniques of the redundant power system set forth above can provide regular power supply in the event of failure of one of the power supplies, when the redundant power system is activated, all the power supplies coupled in parallel on the power backup panel also are activated at the same time.

The activation of all the power supplies at the same time creates following disadvantages:

1. When power requirement of loads is low, some power supplies become unnecessary and surplus, and output of all the power supplies has to be reduced.

2. After the output power is reduced to match the loads, the power supplies are operating in an output range with poor efficiency and result in unnecessary loss.

3. The lost power is in proportion to the number of the power supplies being activated.

4. The lower power output also reduces the lifespan of the power supplies.

Hence it is inappropriate to activate all the power supplies through the power back panel. There is still room for improvement.

### SUMMARY OF THE INVENTION

In view of the conventional redundant power systems that all preset power supplies are activated at the same time no matter in high load or low load condition during activation of the loads to result in waste of electric power and decrease of lifespan thereof, the object of the present invention is to provide a redundant power system to regulate the number of power supplies being activated according to load requirements.

The present invention aims to provide a redundant power system regulating operation according to loads. The redundant power system includes a power back panel and a plurality of power supplies electrically connected to a plurality of input ports located on the power back panel. The power back panel also has a plurality of output ports electrically connected to at least one load. Each power supply has an ON/OFF control terminal to receive an ON/OFF signal to determine ON or OFF thereof. The power back panel further has a power source management unit to detect the number of the load being activated. The power source management unit includes a plurality of ON/OFF signal terminals electrically connected to the ON/OFF control terminals. The power source management unit determines the number of the ON/OFF signal terminals that output the ON/OFF signal according to the number of the load being activated.

By means of the aforesaid technique of the invention, the number of the power supplies being set ON can be determined according to the number of the load being activated. Hence when the number of the load is fewer, the number of the power supplies being set ON also is fewer, therefore power loss can be reduced and the lifespan of the power supplies can be enhanced.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a block diagram of the architecture of the redundant power system of the invention.

FIG. 2 is a schematic circuit diagram of the power back panel of the invention.

FIG. 3 is a schematic circuit diagram of another embodiment of the power back panel of the invention.

### DETAILED DESCRIPTION OF THE PREFERRED EMBODIMENTS

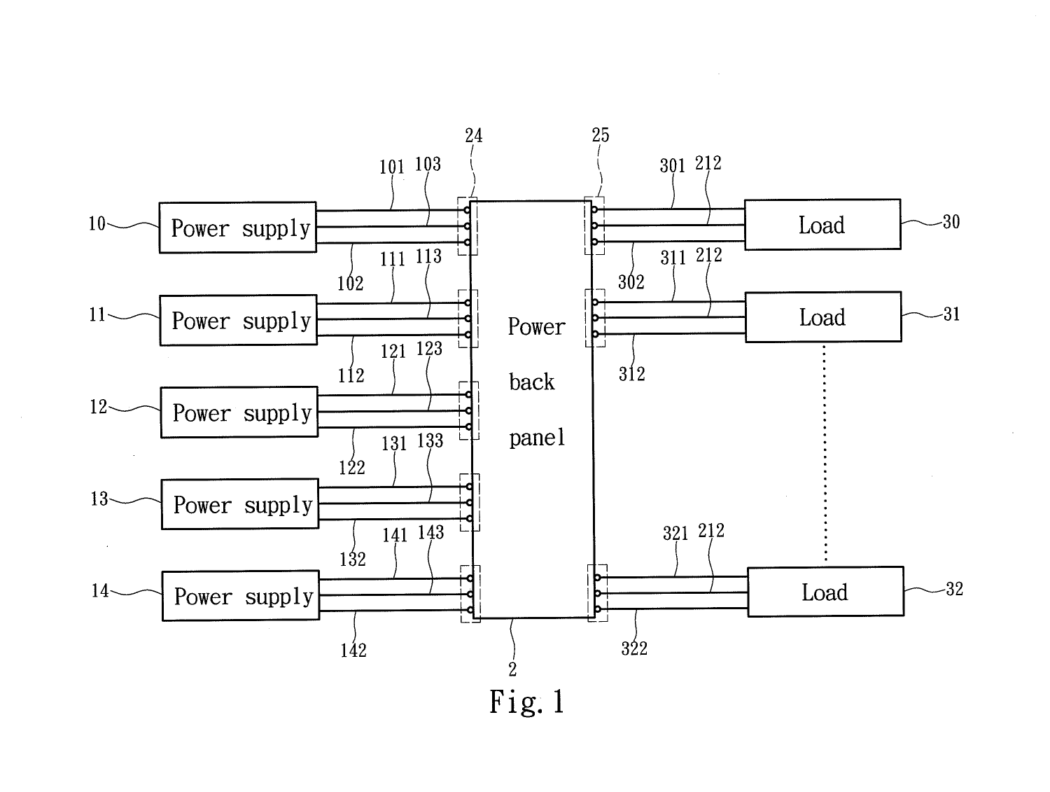

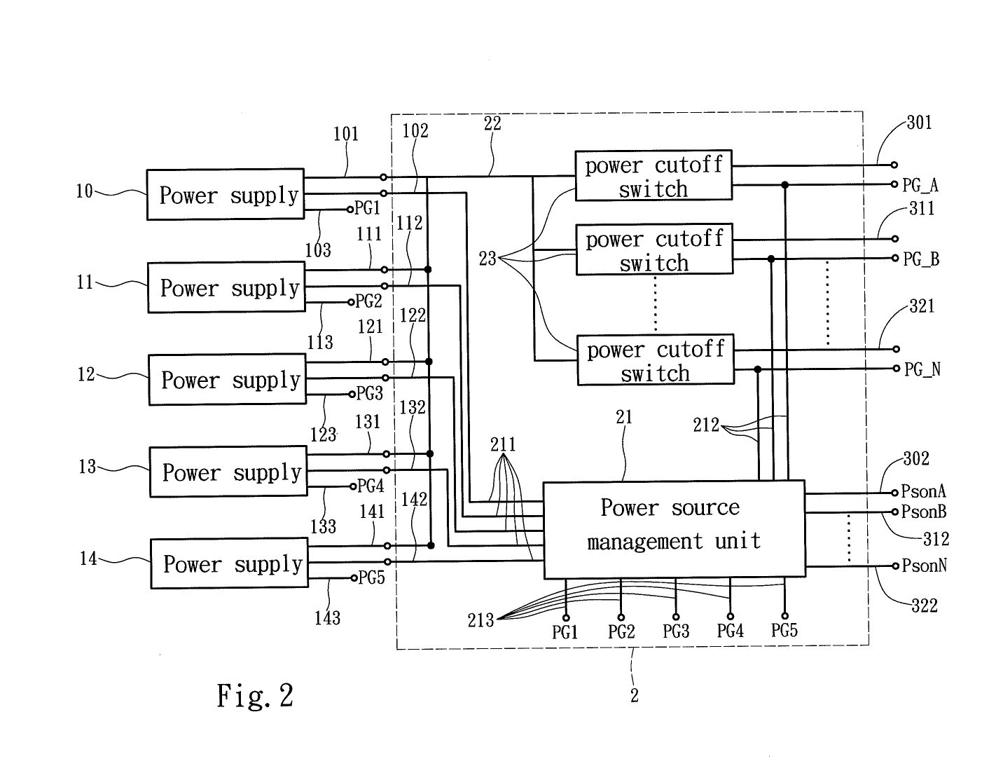

Please refer to FIG. 1, the present invention aims to provide a redundant power system which includes a plurality of power supplies and a power back panel 2. In the drawings, there are five sets of power supplies 10, 11, 12, 13 and 14 provided as an example. The power back panel 2 includes a plurality of input ports 24 electrically connected to the power supplies 10, 11, 12, 13 and 14, and a plurality of output ports 25 electrically connected to at least one load. In the example shown in the drawings, ten sets of loads are provided and connected to the rear terminals of the power back panel 2. To facilitate discussion, some of the loads are not shown in the drawings, only loads 30, 31 and 32 are shown to represent all the loads connected to the power back panel 2. The loads 30, 31 and 32 have respectively a power supply line terminal 301, 311 and 321 to get power from the power back panel 2, and a remote ON/OFF signal terminal 302, 312 and 322 to issue a remote ON/OFF signal (i.e. PS_ON signal stated in the ATX motherboard specification published by INTEL). The power supplies 10, 11, 12, 13 and 14 have respectively a power output terminal 101, 111, 121, 131 and 141, an ON/OFF control terminal 102, 112, 122, 132 and 142 to issue an ON/OFF signal, and an operation signal terminal 103, 113, 123, 133 and 143. When a system operator activates one or more of the loads 30, 31 and 32, the remote ON/OFF signal terminals 302, 312 and 322 of the activated loads 30, 31 and 32 issue a remote ON/OFF signal to the power back panel 2 which detects the number of the activated loads 30, 31 and 32 according to the remote ON/OFF signals, and then determines the number of the ON/OFF signals to be output according to the number of the activated loads 30, 31 and 32. Also referring to an embodiment shown in FIG. 2, the ON/OFF control terminals 102, 112, 122, 132 and 142 of the power supplies 10, 11, 12, 13 and 14 are triggered and activated individually and independently by the ON/OFF signals. As previously discussed, after the number of the output ON/OFF signals have been determined by the number of the activated loads 30, 31 and 32, some or all of the power supplies 10, 11, 12, 13 and 14 will be set ON according to the number of the ON/OFF signals. Referring to FIG. 2, the power back panel 2 includes a power source management unit 21, a power output line 22 to converge power and a plurality of power cutoff switches 23. The power source management unit 21 has a plurality of ON/OFF signal terminals 211 electrically connected to the ON/OFF control terminals 102, 112, 122, 132 and 142 of the power supplies 10, 11, 12, 13 and 14 through the input ports 24, and a plurality of power source status detection terminals 213 electrically connected to the operation signal terminals 103, 113, 123, 133 and 143. The power source management unit 21 gets the remote ON/OFF signals, and then determines the number of the ON/OFF signal terminals 211 to output the ON/OFF signal according to the number of the remote ON/OFF signal. If the system operator activates only the load 30, the power source management unit 21 determines to set the power supplies 10 and 11 ON based on the remote ON/OFF signal sent from the load 30, thus a 1+1 redundant power system including the power supplies 10 and 11 is formed. After the power supplies 10 and 11 are normally set ON, they respectively issue a normal operation signal (PG1, PG2, i.e. PG signals stated in the ATX motherboard specification published by INTEL) through the operation signal terminals 103 and 113 to the power source status detection terminals 213 of the power source management unit 21 in response to the ON/OFF conditions of the power supplies 10 and 11. Thus the power supplies 10 and 11 are ready to supply power through the power output line 22. The power cutoff switches 23 are located on the power output line 22 to determine which output port 25 is electrically connected with the power output line 22. The power source management unit 21 further has a plurality of power output signal terminals 212. The power source management unit 21 detects whether the power supplies 10 and 11 corresponding to the activated load 30 have been normally set ON, and then determines whether to output the power output signals. After receiving the normal operation signal, the power output signal terminal 212 issues at least one power output signal (PG_A, i.e. PG signal sent back to the load 30) corresponding to the number of the activated loads. The power output signal drives the power cutoff switch 23 ON that is located between the load 30 and power output line 22, meanwhile the load 30 can judge that the power back panel 2 has normally output the power through the power output signal.

In the event that the system operator decides to activate four sets of loads, the power source management unit 21 can select to set the power supplies 10, 11 and 12 ON to form a 2+1 redundant power system according to the number of the loads. After the power source management unit 21 has detected normal operation signals (PG1, PG2, and PG3), a plurality of power output signals are sent out to drive the corresponding power cutoff switches 23 ON to transmit power to the loads 30, 31 and 32 to be activated.

The power source management unit 21 can preset the upper limit of the number of the loads to be driven by each of the power supplies 10 through 14, and determine the required number of the power supplies according to the detected number of the activated loads and output one or more ON/OFF signals. The power source management unit 21 also can preset the upper limit of the power provided by each of the power supplies 10 through 14, and determine the required number of the power supplies according to the power requirement of the activated loads and output one or more ON/OFF signals.

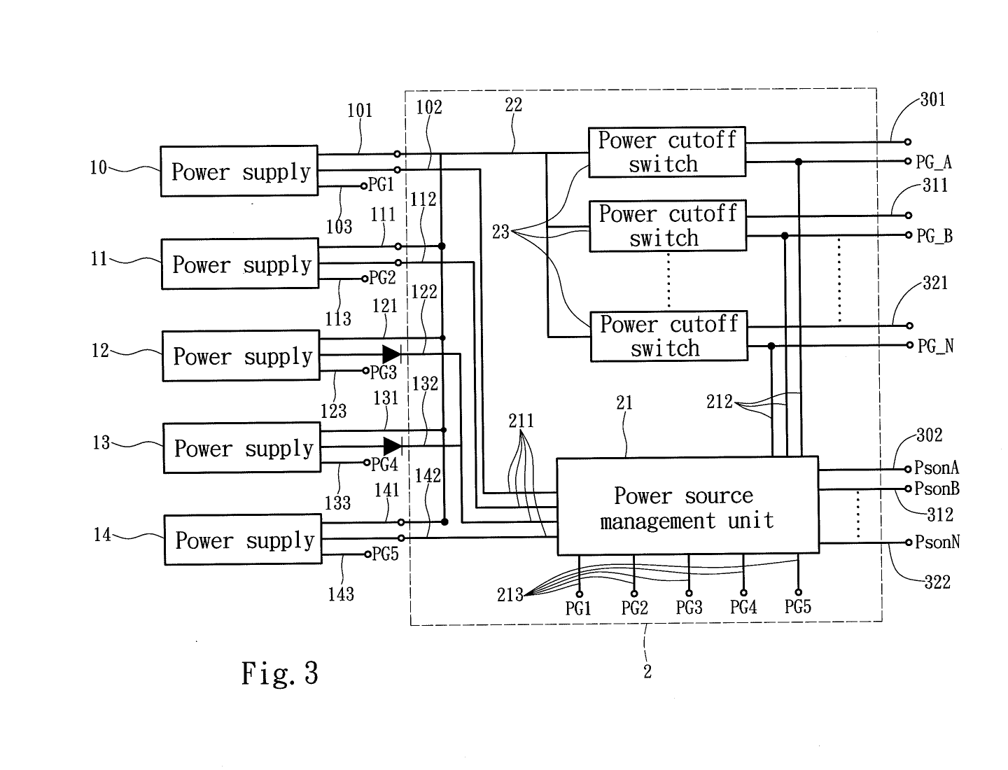

Refer to FIG. 2 for an embodiment in which each ON/OFF signal terminal 211 is electrically connected to the ON/OFF control terminals 102, 112, 122, 132 and 142 of the power supplies 10 through 14. FIG. 3 depicts another embodiment which differs from the previous one by providing a plurality of ON/OFF signal terminals 211 electrically connected to the ON/OFF control terminals 102, 112 and 142 of the power supplies 10, 11 and 14, and at least one ON/OFF signal terminal 211 electrically connected to the ON/OFF control terminals 122 and 132 of the power supplies 12 and 13. Hence the power source management unit 21 not only can select to individually set the power supplies 10, 11 and 14 ON, but also can select to set the power supplies 12 and 13 ON at the same time according to requirements to better meet power requirements of the loads and provide redundant power to enhance system safety.

What is claimed is:

1. A redundant power system regulating operation according to loads including a power back panel and a plurality of power supplies electrically connected to a plurality of input ports of the power back panel, the power back panel including a plurality of output ports electrically connected to at least one load, each of the power supplies including an ON/OFF control terminal to receive an ON/OFF signal to determine ON/OFF thereof, the power back panel further comprising:
a power source management unit which detects the number of the activated load and includes a plurality of ON/OFF signal terminals electrically connected to the ON/OFF control terminals and determines the number of ON/OFF signal terminals to output the ON/OFF signal according to the number of the activated load.

2. The redundant power system of claim 1, wherein each power supply further includes an operation signal terminal to output a normal operation signal in response to ON/OFF conditions of the power supply, the power source management unit including a plurality of power source status detection terminals electrically connected to the operation signal ends.

3. The redundant power system of claim 1, wherein the ON/OFF signal terminal is electrically connected to the ON/OFF control terminal of one power supply.

4. The redundant power system of claim 1, wherein the power source management unit includes a plurality of ON/OFF signal terminals electrically connected to the ON/OFF control terminal of one power supply and at least one ON/OFF signal terminal electrically connected to the ON/OFF control terminals of the multiple power supplies.

5. The redundant power system of claim 1, wherein the power source management unit presets an upper limit of the number of the load driven by each power supply and determines the required number of the power supplies according to the detected number of the activated load to output one or more ON/OFF signals.

6. The redundant power system of claim 1, wherein the power source management unit presets an upper limit of power supplied by each power supply and determines the required number of the power supplies according to power requirements of the activated load to output one or more ON/OFF signals.

7. The redundant power system of claim 1, wherein the power back panel includes a power output line connected to the input ports and the output ports and a plurality of power cutoff switches to determine whether the output ports are electrically connected with the power output line, the power source management unit being electrically connected to the power cutoff switches and providing a plurality of power output signals to set the power cutoff switches ON.

8. The redundant power system of claim 7, wherein the power source management unit detects whether the power supply corresponding to the activated load is set ON normally and determines whether to output the power output signals to allow the output ports connected to the load to be electrically connected with the power output line.

9. The redundant power system of claim 7, wherein the load receives the power output signals to detect the power back panel outputting power regularly.
